(19) United States
(12) Patent Application Publication
(10) Pub. No.: US 2008/0282652 A1
(43) Pub. Date: Nov. 20, 2008

(54) Modular welding or like operation conduit enclosure abstract of the disclosure

(76) Inventor: Louis J. Wardlaw, Houston, TX (US)

Correspondence Address: Beirne, Maynard & Parsons, L.L.P., Ste. 2500, 1300 Post Oak Blvd., Houston, TX, 77056-3000, US

(21) Appl. No.: 11/803,544

(22) Filed: May 15, 2007

(51) Int. Cl. B01D 50/00

(52) U.S. Cl. 55/385.2

(57) ABSTRACT

An inflatable modularly constructed for use over cites near welding or other operations upon, for example, one or more conduit members, in order to retain within the interior structure unwanted gases, flake, slags, sparks and other debris. The modules may be shaped and provided in such numbers as to provide a specific contour with each member being re-usable in combination with other members for subsequent operations. The modular members are selectively secured together so as to be substantially air tight to provide effective inflation of the unit. A framework may also be provided to assist in enhancing effective inflation during work operations. Fans and filter units may be provided for continuous inflation and to filter the intake inflation gas.

An inflatable modularly constructed unit is provided for use over cites near welding or other operations upon, for example, one or more conduit members, in order to retain within the interior structure or in order to retain exterior of the structure unwanted gases, flake, slags, sparks and other debris created during an outdoor welding process. The modules may be shaped and provided in such numbers as to provide a specific contour during the welding operation, with each member of the unit being re-usable in combination with other shaped and numbered members for subsequent operations. The modular members are selectively secured together one to another by so as to be substantially air tight to provide effective inflation of the unit. A framework may also be provided to assist in enhancing effective inflation of the unit during work operations. Fans and filter units may also be provided for continuous inflation of the unit and to filter the intake inflation gas, such as air, and/or the discharge gas.

### BACKGROUND OF THE INVENTION

1. Field of the Invention

The invention relates to a welding enclosure for use in welding or other operations upon, for example, one or more conduit members, such as those on a well head, oil or gas pipeline, or the like.

2. Brief Description of the Prior Art

Subsequent to the drilling of a subterranean oil or gas well, whether such well be located inland, or on a well platform, drill ship, semi-submersible, or the like, the well is completed by introduction of a tubular conduit which is often time referred to as “casing”. The casing is cemented in place as part of the completion operation. Prior or subsequent to the introduction of one or more sections of casing conduit forming the casing string into the subterranean well, it may be necessary or desirable to perform a welding or other operation to one or more ends of the casing to affix, for example, a blowout preventer, or other component desirable to be fixedly secured to the casing conduit section. In many instances, such component will be affixed to such casing conduit member by welding operations well known to those in the industry. As a result of the flame discharge from the welding torch, during the welding operation, or other common operations, sparks, slag and other debris can be expected to be discharged into the air around the welding or other operation resulting in a serious fire hazard during the welding operation. Such slag and sparks could touch off a fire or even worse, an explosion, since the casing often times will be introduced into a “live” well which, at any time, could become uncontrollable as a result of a leak or blowout of flammable fluids, such as natural gas, or the like.

Because many such welding or other associated operations are conducted at very remote locations, such as in jungles, offshore, in desert environments, islands, forests, figid locations, and other hostile environments where transportation is not convenient and weight and size of transported materials is at a premium, it would be desirable to provide materials used in such operations that are light weight in construction, can be reused, and transported in a manner that eliminates wasted and unnecessary cargo space. Furthermore, the geometric configuration of a needed welding enclosure may be expected to vary from one location to another, in size as well as in shape, such that what is satisfactory for one location and operation would be considered disadvantageous for another particular location.

The present invention addresses the problems as set forth above. The relevant prior art of which applicant is aware is as reflected in the following U.S. patents:

U.S. Pat. No. 5,101,604, entitled “Subterranean Welding Habitat”.

U.S. Pat. No. 5,018,321, entitled “Subterranean Welding Habitat”.

U.S. Pat. No. 2,872,933, entitled “Air-drilling Rig Cover”.

U.S. Pat. No. 3,308,266, entitled “Method and Apparatus for Welding of Rails”.

U.S. Pat. No. 3,837,171, entitled “Inflatable Underwater Structure”.

U.S. Pat. No. 3,946,571, entitled “Service Module for Environment”.

U.S. Pat. No. 3,991,583, entitled “Method of Providing an Underwater Enclosure”.

U.S. Pat. No. 4,257,720, entitled “Apparatus and Method for Driving Members Into the Ocean Floor”.

The following patents also are known to applicant and are of general interest:

U.S. Patents.

| Patent No: | Issue date: | Inventor: |
|---|---|---|
| 2872933 | February 1959 | Mackey |
| 3250024 | May 1966 | Douthitt et al. |
| 3335529 | August 1967 | Gedney |
| 3452764 | July 1969 | Bell |
| 3525290 | August 1970 | Pelsue |
| 3626836 | December 1971 | Schneidler |
| 3783906 | January 1974 | Matherne |
| 3946571 | March 1976 | Pate et al. |

Foreign Patent Documents

| Patent No: | Issue date: | Inventor: |
|---|---|---|
| 681345 | September, 1939 | DE2 |
| 2135965 | February, 1973 | DE |
| 497787 | December, 1938 | GB |

### SUMMARY OF THE INVENTION

A modular welding or other operations enclosure unit has an exterior and an interior, for entrapment of welding slag, sparks, and the like within said interior during welding along at least one fluid conduit member forming a fluid transmission line. As used herein, “conduit member” or “conduit” means any surface upon which a heat or other operation, such as welding, is to be conducted, and wherein such operation results in the creation or use of gases, slag, dust, sparks, and similar resultant materials, which are desired to be contained within a controlled environment during the heating operation. Such “conduits” include surfaces on blow out preventers, oil and gas transmission lines, and the like.

A plurality of selectively joinable and selectively separable inflatable members are provided which, when joined, form a modular unit mounted over a point along the conduit member and upon which a welding or heating procedure is to be conducted. Means on each of the inflatable members are also provided for selectively joining to and selectively separating from said inflatable members at least another of said inflatable members whereby, when joined to one another and when positioned over the conduit member, the inflatable members may be inflated and retained inflated to form the modular unit during welding on the conduit member.

The device of the present invention may be used to also prevent debris, such as sparks, and the like, from entering within the interior of the device while an “operation”, such as welding, or the like, is being conducted exterior of the device, on an offshore platform, or any other location, such as a refinery, chemical plant, or the like.

### BRIEF DESCRIPTION OF THE DRAWINGS

FIG. 1 is a perspective view of the present modular unit shown in inflated position over a conduit work area.

FIG. 2 is a view similar to that in FIG. 1, but taken interiorally during a welding operation.

FIG. 3 is an exterior view of an embodiment having a dome-like configuration with an exterior support frame.

FIG. 4A is a view of an embodiment of the present invention illustrating a modular pyramid-like geometric configuration of inflatable members.

FIGS. 4B and 4C are views of a selectively collapsible internal support frame structure for the pyramid-like geometric configuration modular unit shown in FIG. 4A.

FIG. 5 is an exterior view of a preferred embodiment of the present invention in perspective with incorporation of an exterior support frame.

### DESCRIPTION OF THE PREFERRED EMBODIMENT

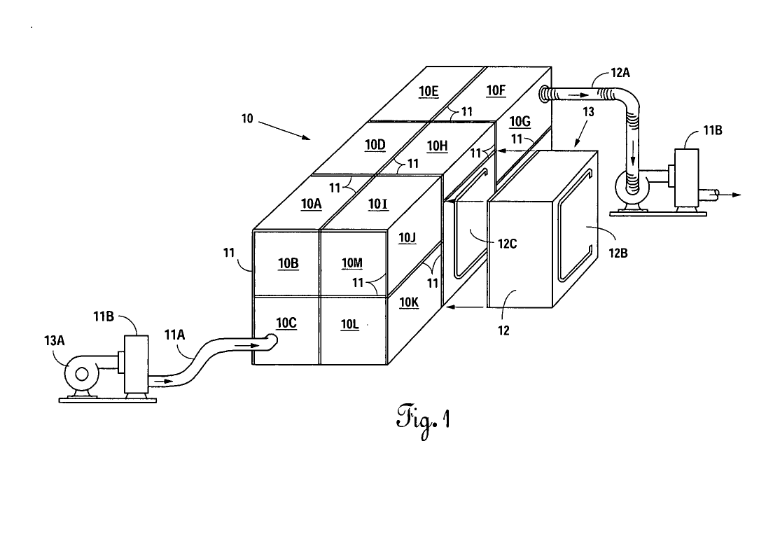

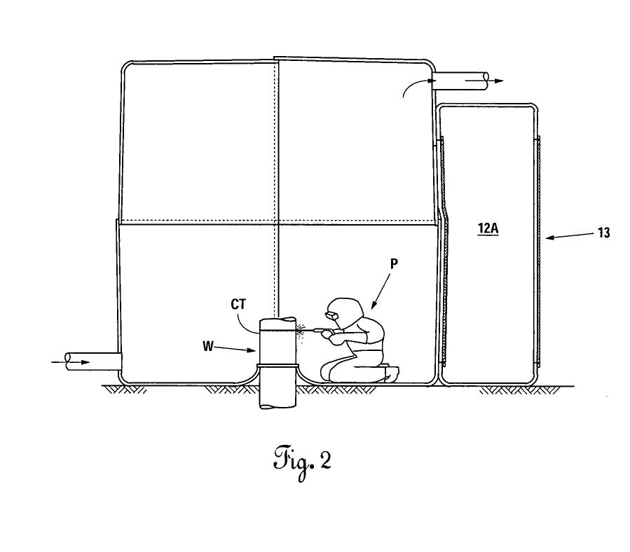

Now with first reference to FIG. 1, there is shown the modular unit 10 in inflated position over a conduit, such as a well head W of an oil or gas subterranean well (FIG. 2). The unit 10 is composed of a series of separate module or inflatable members, 10A-10M, which are secured one to another prior to inflation by means of companion VELCRO strips 11 secured around the outer edges pf each inflatable member. An air lock 12 is provided with an opening 12A (FIG. 2) through which a worker P (FIG. 2) may enter and exit. The air lock has a flap member 12B thereon which may be opened or closed both interiorally and exteriorally after the worker P has passed through it, to maintain inflation integrity during the welding operation.

It will be appreciated that the inflation members 10A-M forming the unit 10 do not have to be absolutely air tight at the interface of the VELCRO strips 11, and only have to assure that the unit 10 may be inflated and maintained in inflated position during the welding or heating operation therewithin. High volume electric fans 13A and 13B are provided, with one of the fans being an intake fan, such as 13A, and the other fan being an exhaust or discharge fan 13B are provided, preferable at opposite ends of the unit 10, for introduction of a gas, such as air, or any other inert gas, such as nitrogen, or the like, into and throughout the unit 10 to inflate it and maintain it in inflated position over the selected work area.

The modular inflation members 10A-M are preferable made of material that is comparatively light in weight as well as fire resistant or fire retardant, in order to assure that high temperature sparks are retained within the interior of the unit 10 and do not penetrate through the fabric, forming holes.

The inflatable body 10 may be made of a material comprising a member selected from the class consisting of:

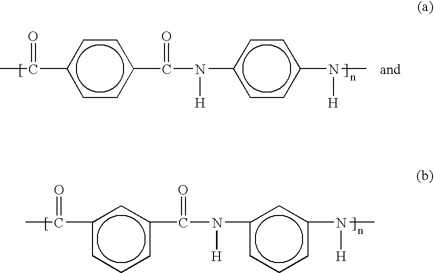

In Nomex the aromatic groups are all linked into the backbone chain through the 1 and 3 positions. This is called meta-linkage.

Such a material is commercially available from the DuPont Chemical Company and is sold under the trademark NOMEX. In this product, the aromatic groups are all linked into the backbone chain through the 1 and 3 positions. This is typically referred to as meta-linkage. NOMEX is the registered brand name of a flame retardant meta-aramid material marketed and first discovered by DuPont in the 1970s. It can be considered an aromatic “nylon”. It is sold in both fiber and sheet forms and is used as a fabric wherever resistance from heat and flame is required. Nomex sheet is actually a calendared paper and made in a similar fashion. The paper is used in electrical laminates such as circuit boards and transformer cores as well as fireproof honeycomb structures were it is saturated with a phenolic resin. Both the firefighting and vehicle racing industries use NOMEX to create clothing and equipment that can stand up to intense heat. It is the meta variant of the para-aramid Kevlar. Both aramids are heat and flame resistant but Kevlar, having a para-orientation can be molecularly aligned and gives high strength. Meta aramid polymer cannot align during filament formation and has poor strength.

Plastics are moldable chemically-fabricated (synthetic) materials derived mostly from fossil fuels, such as oil, coal or natural gas. The long molecules in plastics are composed of carbon atoms linked into chains. One type of plastic, polyethylene, is composed of extremely long molecules, each containing over 200,000 carbon atoms. These long molecule chains give plastics unique properties and distinguish plastics from material such as metal that have crystalline structures. Fossil fuels contain hydrocarbons, which provide the building blocks for long polymer molecules. The building blocks called monomers link together to form long carbon chains called polymers. The process of forming these long molecules from hydrocarbons is called polymerization. The molecules typically form viscous sticky substances known as resins which are the materials used to make plastic products or articles by heating the resins to their specific melting range and molding them into articles by various methods.

The carbon backbone of polymer molecules often bond with smaller side chains consisting of other elements, including chlorine, fluorine, nitrogen and silicon, for example. These side chains give plastics distinguishing characteristics. For example, when chlorine atoms substitute for hydrogen atoms along the carbon chain, the result is polyvinyl chloride, one of the most versatile and widely used plastics in the world.

The addition of chlorine makes the plastic harder and more resistant. The advantages and disadvantages of different plastics are associated with the unique chemistry of each plastic which determines the physical, mechanical and thermal properties of the molded article.

Examples of commonly used thermoplastics which may be sued in forming the body 10 are: polyethylene (PE), polyvinyl chloride (PVC), polypropylene (PP), polystyrene (PS), polyethylene terephthalate (PET), acrylonitrile butadiene styrene (ABS), polymethyl methacrylate (PMMA), polyamide (PA) and polycarbonate (PC). In addition, many variations and hybrid engineered resins based on these are in use today.

Many different processes can be used to make products from thermoplastics for use as the body 10 herein. Some of the more common of these processes are injection molding, extrusion molding, blow molding, injection blow molding, blow film extrusion, calendaring, thermoforming, casting and expansion processes. In all these processes, the plastic must be softened or sufficiently liquefied in order to allow the resin to flow and create the shape of the article. For convenience, all these plastic resin forming processes will be simply referred to as “molding process” hereinafter.

The inflatable members 10A-M, etc. are preferably made of fire resistant or fire retardant textile materials. Outer textile materials for fire fighting clothing are useful for the formation of the members 10A-M. Such materials have previously been manufactured from 100% meta-aramid or polyamideimide blends of meta-aramid and para-aramid fibres or by use of core spun yarns or staple mixtures with polyparaphenylene terephthalamide copolymer or fibres comprising para-aramid cores with meta-aramid or polyamideimide covers. The combination of these fibres in the fabric enhances the non-break open protection of the product. However meta-aramid and polyamideimide fibres shrink, consolidate and thicken when exposed to a high temperature beat source. The presence of para-aramid or polyphenylene terephthalamide copolymer in either the fibre blend or as a core can be used to prevent fibre shrinkage and consequent breaking open of the garment. However the inclusion of para-aramid fibre in the blend has been found to be insufficient in tightly woven fabrics to prevent breaking open and does not increase the air gap between the wearer and the heat source. Consequently there is a need for improved textile materials for manufacture of fire fighting garments and the like.

Fire fighting garments, which may be used in the manufacture of the inflatable members 10A-M have been made from a plurality of textile layers, including an outer layer of woven meta-aramid fibre, for example as manufactured under the trademark Nomex as previously stated. Break open protection may be afforded by blending with para-aramid fibres, e.g. as manufactured under the trademark Kevlar and as disclosed in U.S. Pat. No. 3,063,966 and U.S. Pat. No. 3,506,990.

PCT/GB00/01449 discloses a fire resistant textile material comprising a woven face fabric composed of fibres selected from meta-aramid, polyamideimide and mixtures thereof, the fabric including a woven mesh of low thermal shrinkage fibres. Also useful for incorporation into the members 10A-M is a woven faced fabric composed of face fibres selected from meta-aramid, polyamideimide and mixtures thereof the fabric including a woven back of low thermal shrinkage fibres, wherein the overfeed of the lower thermal shrinkage fibres is selected so that the sum of the extension under load and take-up is approximately equal to the extension under load and take-up of the face fibres. Such product is known as Kevlar®. This product is a polyamide, in which all the amide groups are separated by para-phenylene groups, that is, the amide groups attach to the phenyl rings opposite to each other, at carbons 1 and 4. Kevlar® is shown as follows:

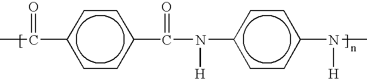

In Kevlar the aromatic groups are all linked into the backbone chain through the 1 and 4 positions. This is called para-linkage.

Novex® on the other hand, has meta-phenylene groups, that is, the amide groups are attached on the phenyl ring at the 1 and 3 positions.

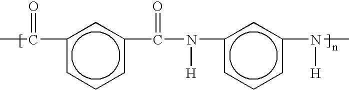

In Nomex the aromatic groups are all linked into the backbone chain through 1 and 3 positions. This is called meta-linkage.

Around the edges of each of the modular inflatable members 10A-J is sewn or otherwise secured hook and loop closure components, sometimes referred to as VELCRO, or the like. Alternatively, snaps, buttons, zippers, ties, eye-hooks, hooks with mating means, etc or the like could easily be integrated or sewn, stitched, glued, grommeted, etc in such a way that they provide the same or similar buckling/closure means for each of the modular inflatable members 10A-M.

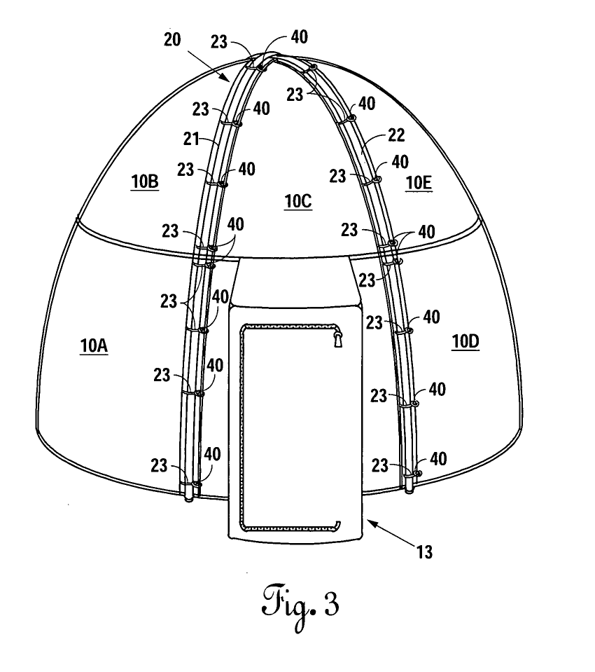

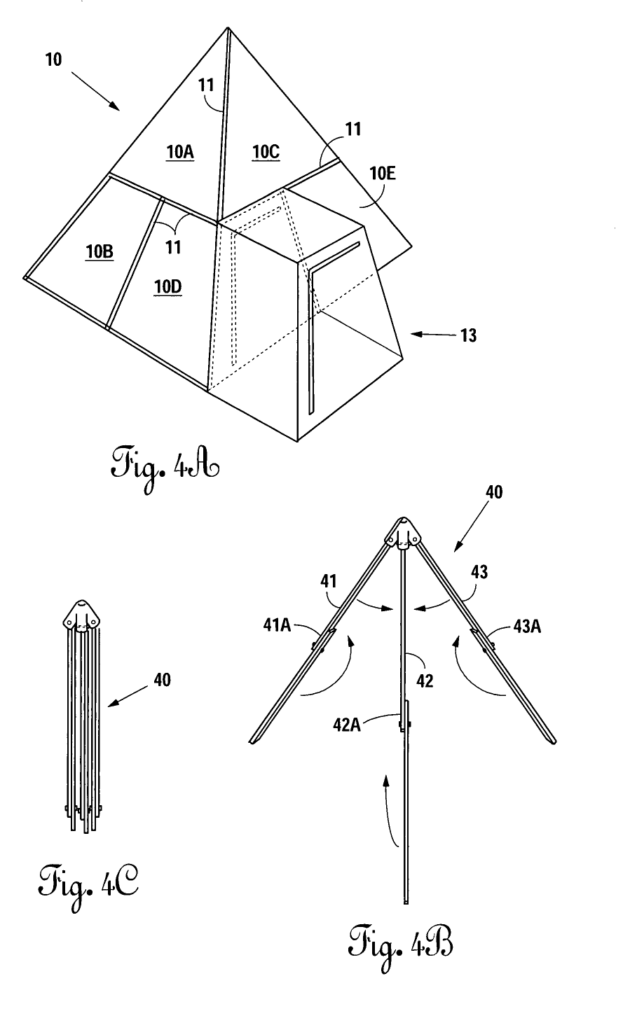

The modular inflatable members 10A-M may be provided in any of a number of sizes and geometrical configurations. For example, FIG. 3 illustrates the unit 10 formed of modular inflatable members 10A, etc. such that the entire unit 10 takes the shape of a dome-like structure. Similarly, FIG. 4A illustrates a pyramid-like configuration that might be built when using inflatable members 10A, etc. in the geometric configuration shown therein.

With continued reference to FIG. 1, the unit 10 also includes electric or other power driven intake and exhaust fans 13A and 13B, secured to the inflatable unit 10 at opposite ends thereof through connecting conduit members 11A and 12A, respectively. In order to abate the entry and exit of particulate matter into and out of the interior of the inflated unit 10, filters 11B and 12B are provided along and traversing the conduit members 11A and 12A.

Also particularly shown in FIGS. 1, 3 and 4A, an air lock 13 is provided having opening panels 12B and 12C to permit entry and exit of a workman into and out of the interior if the inflated unit 10, without substantial loss of effective inflation pressure within the interior of the unit 10.

FIG. 2 is an illustration of the embodiment of FIG. 1, in cross-section, to illustrate a workman P during a welding procedure onto a conduit member CT of a subterranean well.

FIG. 3 is an exterior view of a geometric variant of the invention of FIGS. 1 and 2, illustrating the use of modular inflatable members 10A-E designed to provide a dome-like unit 10, when assembled and inflated.

As illustrated in FIG. 3, the frame structure 20 consists of two arms 21 and 22 that may be placed in overlapping position 23 relative to one another at the top of the dome unit 10. When placed on the exterior of the dome unit 10, the arms 21 and 22 may be secured about the exterior by plurality of lines or ties 23 to securements 40 spaced about the exterior of the unit 10.

Alternatively, the arms 21 and 22 may be placed interiorally of the dome configured unit 10, with like securement to the interior walls of the inflatable members 10A, etc.

Now turning to FIGS. 4B and 4C, there is shown a normally collapsed support tripod framework structure 40 for use interiorally within the pyramid-like unit 10 of FIG. 4A. The tripod frame structure 40 has three collapsible leg members 41, 42 and 43 which may be rotated at connections 41A, 42A and 43A to collapse the unit for storage and transportation, as shown in such position in FIG. 4C. The framework 40 is either installed after the unit 10 has been inflated, or the unit 10 may be constructed using members 10A-E being placed around it before inflation. After installation, ties, snaps, or the like (not shown) may be used to secure the respective members 10A-E to the respective legs 41, 42, or 43.

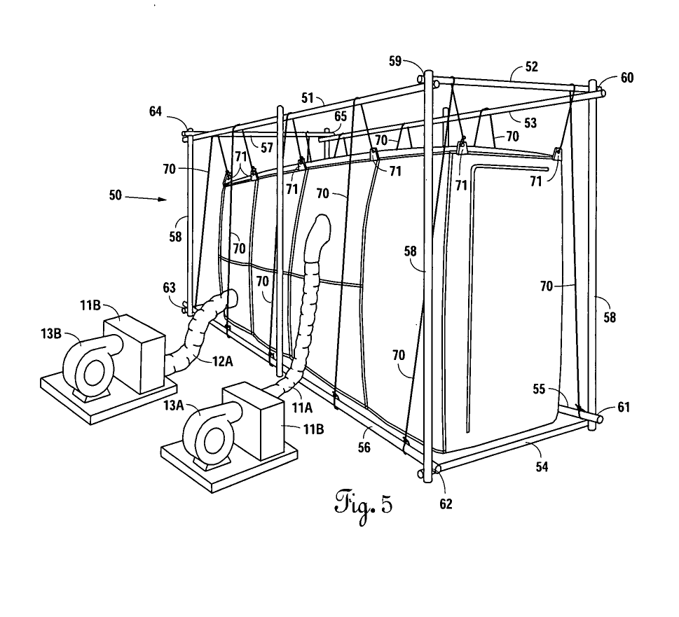

FIG. 5 is an exterior elevational view of a preferred unit 10, including an exterior support framework 50. The framework 50 has upper and lower horizontal members 51, 52, 53, 54, 55, 56. 57 and 58. The end horizontal members 57, 52, 54 and 58 are secured to the other respective horizontal members by means, such as by removable bolts and nuts, or the like, at points 59, 60, 61, 62, 63, 64 and 65 (final corner securement not shown). Finally, the unit 10 is secured to the framework or structure 50 by means of a series of ties, lines or ropes 70 fastened to the exterior of the unit 10 at securement points 71.

As will be appreciated, the invention provides a light weight heat resistant modular device having panels or members that can be provided in a number of convenient sizes and shapes to provide a device that can be easily shipped and assembled in conformity to the individual needs at the work location. While not flame proof, the material used to make the panels or members are contemplated to be flame or fire resistant up to about 1,000 F. Such materials will not combust immediately when exposed to the naked flame, and will cease burning in approximately thirty minutes. The unit 10 as disclosed has an air-lock door system that seals the interior with positive internal pressure.

It will also be appreciated that several refinements may be made to the preferred and other embodiments, such as by adding window panels.

Furthermore, it will be appreciated that the fans or blowers may be supplied to areas where there is no space to locate a compressor and the use of rig air is not allowed.

Additionally, it will be appreciated that the use of the present modularly constructed unit eliminates the need to shut down a platform during welding and other operations.

The modular unit of the present invention may be used to access doors, utility stations and fire systems regardless of their physical location. It may be used to provide a safe environment for installation of patches on pipe, and/or crossovers over flow lines, as well as repairs to risers and structural welds of numerous kinds.

Although the invention has been described in terms of the embodiments as shown, the invention is limited only by the scope of the appended claims. Those skilled in the art will readily perceive alternative embodiments once this specification is read and understood.

What is claimed and desired to be secured by Letters Patent is:

1) A modular welding enclosure unit having and exterior and an interior, for entrapment of welding slag, sparks, and the like within said interior during welding along at least one fluid conduit member forming a fluid transmission line, comprising;
(a) a plurality of selectively joinable and selectively separable inflatable members which, when joined, form said modular unit mounted over a point along said conduit member and upon which a welding procedure is to be conducted; and
(b) means on each of said inflatable members for selectively joining to and selectively separating from said inflatable members at least another of said inflatable members whereby, when joined to one another and are positioned over the said conduit member, the inflatable members may be inflated and retained inflated to form said modular unit during welding on said conduit member.

2) The modular welding enclosure of claim 1 further comprising means secured to one of said inflatable members for initiating and maintaining inflation of said unit.

3) The modular welding enclosure of claim 1 further comprising means secured to one of said inflatable members for initiating and maintaining inflation of said modular unit, and including at least one intake fan and at least one exhaust fan, each of said fans including an inflation gas conduit member having an inflation gas passageway extending from said fan and through an inflatable member for introduction of said inflation gas into, through and out of said unit.

4) The modular welding enclosure of claim 1 further comprising means secured to one of said inflatable members for initiating and maintaining inflation of said unit, and including at least one intake fan and at least one exhaust fan, each of said fans including an inflation gas conduit member having an inflation gas passageway extending from said fan and through an inflatable member; and further comprising filter means disposed through each of said inflation gas passageways for removal of particulate matter as the inflation gas is introduced into, through and out of said modular unit.

5) The modular welding enclosure of claim 1 further comprising a support frame structure extending over and around the exterior of said modular unit to support said modular unit while inflated and during welding on said conduit member.

6) The modular welding enclosure of claim 1 further comprising a support frame structure extending over and around the exterior of said modular unit to support said modular unit while inflated and during welding on said conduit member, said support frame structure including a series of upper and lower horizontally positioned members secured between a plurality of vertically positioned spacing members and further including elongated members exteriorally securable to a plurality of said inflatable members and attachable upon at least one of said horizontal and vertical members to enhance inflation of said modular unit.

7) The modular welding enclosure of claim 1 further comprising a support frame structure having members positioned interiorally of said unit.

8) The modular welding enclosure of claim 1 further comprising a support frame structure having members, each member including a series of normally collapsed elements secured to one another and expandable to supporting position against the interior of at least one inflatable member when the modular unit is inflated.

9) The modular welding enclosure of claim 1 wherein the means on each of said inflatable members for selectively joining to and selectively separating from said inflatable members at least another of said inflatable members comprises length of hook and loop closure, snaps, buttons, zippers, ties, eye-hooks, or hooks with mating means that are integratedly sewn, stitched, glued, or grommeted upon each of the inflatable members.

10) The modular welding enclosure of claim 1 wherein the inflatable members comprise a member selected from the class consisting of:

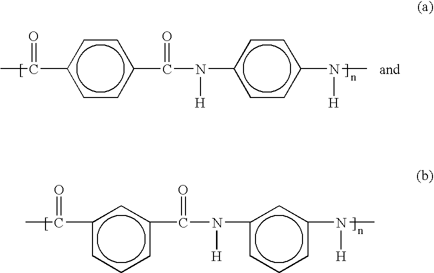

11) A modular enclosure unit having and exterior and an interior, for entrapment of welding slag, sparks, debris, and the like within said interior during an operation along at least one fluid conduit member forming a fluid transmission line, comprising;
(a) a plurality of selectively joinable and selectively separable inflatable members which, when joined, form said modular unit mounted over a point along said conduit member and upon which an operation is to be conducted; and
(b) means on each of said inflatable members for selectively joining to and selectively separating from said inflatable members at least another of said inflatable members whereby, when joined to one another and are positioned over the said conduit member, the inflatable members may be inflated and retained inflated to form said modular unit during said operation on said conduit member.

12) The modular enclosure of claim 11 further comprising means secured to one of said inflatable members for initiating and maintaining inflation of said unit.

13) The modular enclosure of claim 11 further comprising means secured to one of said inflatable members for initiating and maintaining inflation of said modular unit, and including at least one intake fan and at least one exhaust fan, each of said fans including an inflation gas conduit member having an inflation gas passageway extending from said fan and through an inflatable member for introduction of said inflation gas into, through and out of said unit.

14) The modular enclosure of claim 11 further comprising means secured to one of said inflatable members for initiating and maintaining inflation of said unit, and including at least one intake fan and at least one exhaust fan, each of said fans including an inflation gas conduit member having an inflation gas passageway extending from said fan and through an inflatable member; and further comprising filter means disposed through each of said inflation gas passageways for removal of particulate matter as the inflation gas is introduced into, through and out of said modular unit.

15) The modular enclosure of claim 11 further comprising a support frame structure extending over and around the exterior of said modular unit to support said modular unit while inflated and during said operation on said conduit member.

16) The modular enclosure of claim 11 further comprising a support frame structure extending over and around the exterior of said modular unit to support said modular unit while inflated and during said operation on said conduit member, said support frame structure including a series of upper and lower horizontally positioned members secured between a plurality of vertically positioned spacing members and further including elongated members exteriorally securable to a plurality of said inflatable members and attachable upon at least one of said horizontal and vertical members to enhance inflation of said modular unit.

17) The modular enclosure of claim 11 further comprising a support frame structure having members positioned interiorally of said unit.

18) The modular enclosure of claim 11 further comprising a support frame structure having members, each member including a series of normally collapsed elements secured to one another and expandable to supporting position against the interior of at least one inflatable member when the modular unit is inflated.

19) The modular enclosure of claim 1 wherein the means on each of said inflatable members for selectively joining to and selectively separating from said inflatable members at least another of said inflatable members comprises length of hook and loop closure, snaps, buttons, zippers, ties, eye-hooks, or hooks with mating means that are integratedly sewn, stitched, glued, or grommeted upon each of the inflatable members.

20) A modular enclosure unit having and exterior and an interior, for prevention of welding slag, sparks, debris, and the like exterior thereof from entering within said interior during an operation immediate a work site at which an operation is to be conducted comprising;
(a) a plurality of selectively joinable and selectively separable inflatable members which, when joined, form said modular unit mounted over a point upon which an operation is to be conducted; and
(b) means on each of said inflatable members for selectively joining to and selectively separating from said inflatable members at least another of said inflatable members whereby, when joined to one another and are positioned over the said work cite, the inflatable members may be inflated and retained inflated to form said modular unit during said operation.
